(19) United States
(12) Patent Application Publication
(10) Pub. No.: US 2025/0270515 A1
(43) Pub. Date: Aug. 28, 2025

(54) USE OF CYTOPROTECTANT FORMULATIONS IN CELL OR TISSUE TRANSPORT AND/OR STORAGE

(71) Applicant: Marizyme, Inc., Jupiter, FL (US)

(72) Inventors: Cathy Pachuk, Jupiter, FL (US); Satish Chandran, Jupiter, FL (US)

(21) Appl. No.: 18/866,089

(22) PCT Filed: May 13, 2023
(86) PCT No.: PCT/US2023/022158

§ 371 Date: Nov. 15, 2024

Related U.S. Application Data
(60) Provisional application No. 63/342,370, filed on May 16, 2022.

(51) Int. Cl. C12N 5/00

(52) U.S. Cl. CPC C12N 5/526

(57) ABSTRACT

A method for storing or transporting cells, tissues or organs including: preparing a cytoprotectant formulation by mixing a first precursor solution including a balanced salt solution having a pH of from 7.6 to about 8.0 and a second precursor solution comprising water, D-glucose, glutathione, ascorbic acid, and optionally L-arginine at a pH of about 3-5; extracting cells, tissues or organs during a biopsy procedure; and storing or transporting the cells, tissues or organs in the cytoprotectant formulation. The cytoprotectant formulation can also be prepared by reconstituting a powder formulation in a saline or sterile water media to form a cytoprotectant formulation, where the powder formulation includes a reducing agent, an antioxidant, a sugar, a buffering agent, physiologically acceptable salts, optionally a nitric oxide substrate, and is reconstituted at a point of use in a saline or sterile water media.

### FIELD OF THE INVENTION

The present invention is directed to use of cytoprotectant formulations that support the viability of cells and tissues during transport and prior to processing, and more particularly to methods of transporting or storing cells or tissues in cytoprotectant formulations to support the viability of cells and tissues harvested during biopsy procedures during transport and prior to processing and fixation of the harvested cells and tissues. The present invention is also directed to use of cytoprotectant formulations that support the viability of cells during periods of planned ischemic or hypoxic incubation. Also provided are methods of storing cell culture cells, comprising combining the cells with the cytoprotectant formulations provided herein and storing the combination at a temperature in a range of 1° C. to 40° C.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions, or is known to be relevant to an attempt to solve any problem with which this specification is concerned.

The teachings of all references cited herein are incorporated in their entirety by reference.

When biopsy procedures are carried out as out-patient procedures, the biopsy tissues have to be stored during transport to and prior to testing at a clinical laboratory. During such storage and transport procedures, tissues are generally stored in normal saline and subsequently “fixed” with a formalin-based fixative. Biopsy samples are also stored in a saline handling solution when obtained during in-patient procedures. During inpatient procedures the samples are either transported to a pathology lab within the inpatient center or transported to another lab for analysis. It has been shown that storage in the saline handling solution can result in abnormal cellular and architectural changes in the stored/transported tissues, as described by Sengupta et al. (“Artifacts Produced by Normal Saline When Used as a Holding Solution for Biopsy Tissues in Transit,” J. Maxillofac. Oral. Surg., vol. 12(2), pp. 148-51 (2014)), making it difficult to accurately identify and diagnose underlying abnormalities in the cells or tissues. In some cases, the damage is such that the cellular and tissue changes resemble changes associated with certain pathologics and misdiagnoses can occur. Studies by Sengupta et al. on normal oral soft tissues stored in normal saline for 1 to 36 hours before being fixed in 10% formalin have demonstrated the development of various regressive alterations in the epithelium and connective tissue, such as cell vacuolization in the basal layer after 1 hour, widespread vacuolization after 3 hours, loss of cellular integrity after 12 hours, observation of anucleated cells after 24 hours and total lysis of cellular architecture after 36 hours.

These results demonstrate the need for a storage and transport solution for biopsied cells and tissues prior to the analysis and testing of the collected cells and tissues, which does not result in storage artifacts including tissue necrolysis, regressive alterations and other changes to the stored cells and tissues that could interfere with accurate diagnoses of underlying abnormalities in cells and tissues.

Cells also are used for research, cell therapy, and tissue engineering. For example, stem cells, induced pluripotent cells, multipotent cells, differentiated cells, cell lines, primary cell cultures, and other types of cells can be used for research or therapeutic purposes. For storage and transport of cell culture in cell culture medium under hypoxic conditions, or research conducted under hypoxic conditions, tissue culture media does not support anaerobic metabolism and does not protect against oxidative damage and may actually promote oxidative damage when media is supplemented with iron and/or other metals. Accordingly, a need exists for a method for storing cells, such as for transportation from one area to another, and that retains the viability of the cells. The cytoprotectant formulation described herein is biocompatible and can reduce oxidative damage and oxidative stress during these hypoxic intervals, and under similar hypoxic and/or ischemic conditions.

### SUMMARY

Provided are methods of storing and/or transporting cells, tissues or organs, and biopsies derived from cells, tissues and organs, the methods including bringing the cells, tissues or organs and biopsies derived from cells, tissues and organs, into contact with a cytoprotectant formulation, and storing the cells, tissues or organs and biopsies derived from cells, tissues and organs, in the cytoprotectant formulation. The cells, tissue, or organs, and biopsies derived from cells, tissues and organs, can be stored in the cytoprotectant formulation for periods of time that allow them to be transported from one location to another, such as for about 30 seconds, about 1 minute, about 5 minutes, about 10 minutes, about 30 minutes, about 1 hour, about 5 hours, about 10 hours, about 24 hours, about 48 hours, about 72 hours, about 168 hours, and the like, including any intervening time. The cells, tissue, or organs, and biopsies derived from cells, tissues and organs, can be stored in the cytoprotectant formulation at temperatures that allow them to be transported from one location to another while maintaining viability such as about 1° C., about 2° C., about 3° C., about 4° C., about 5° C., about 10° C., about 15° C., about 20° C., about 25° C., about 30° C., about 35° C., about 40° C., and the like, including any intervening temperatures. The cytoprotectant formulation used in the methods can be reconstituted from a powder formulation, or can be a liquid formulation.

The present invention is directed to use of a cytoprotectant formulation that includes three primary components: glutathione, ascorbic acid, glucose, and optionally L-arginine, in combination with a balanced salt solution as a storing or transport vehicle. The cytoprotectant formulation may be a liquid that is separated into a first Solution A including a balanced solution and having a pH of at least 7, generally 7.4-8, and a second Solution B having a pH of less than 7, preferably about 5, 4, or 3. When mixed together to generate the cytoprotectant storage and transport solution, the pH is physiological at about pH 7.3+/−0.4. Solution B includes water, an antioxidant such as ascorbic acid, a reducing agent such as L-glutathione, optionally a nitric oxide substrate such as L-arginine and a sugar such as D-glucose. Solution B preferably has an oxygen content of close to zero parts per million. In other stable embodiments, the sugar can be added to Solution A instead of Solution B. Alternatively, the cytoprotectant formulation used in the methods can be a powder composition, and depending upon the formulation, can be reconstituted into a saline solution or water-for-injection (WFI) at point of use.

The cytoprotectant formulation, which can be formed by mixing Solutions A and B or reconstituting a powder formulation, as described herein, can be used as a storage and/or transport solution and can also be used to maintain viability of cells, tissues and organs and biopsies derived from cells, tissues and organs. The tissues or organs can include, but are not limited to, fat or fat tissue grafts, saphenous veins, mammary tissue, internal thoracic/mammary arteries, epigastric arteries, gastroepiploic arteries, radial arteries, mammary tissues, heart, lungs, kidney, brain, muscle grafts, skin, intestine, bone, appendages, eyes, portions of said tissues or organs, and the like. The cells can include, but are not limited to, stem cells, induced pluripotent cells, multipotent cells, differentiated cells, cell lines, primary cell cultures, 3D cell cultures, and other types of cells that can be used for research or therapeutic purposes, and the like, including cells stored during periods of planned ischemic or hypoxic incubation conditions. Such cells, tissues and organs can include those used in research or therapeutic purposes, but are not limited thereto.

An exemplary embodiment of this invention is a method for storing or transporting cells, tissues or organs, including biopsies of said cells, tissues and organs comprising: reconstituting a powder formulation in a saline or sterile water media to form a cytoprotectant formulation; extracting the cells, tissues or organs during a biopsy procedure; bringing the cells, tissues or organs into contact with the cytoprotectant formulation, and storing the cells, tissues or organs, including biopsies of said cells, tissues and organs, in the cytoprotectant formulation, wherein the powder formulation comprises a reducing agent; an antioxidant; a sugar; a buffering agent; physiologically acceptable salts; and optionally a nitric oxide substrate, and wherein the powder formulation when reconstituted at a point of use in a saline or sterile water media forms a reconstituted formulation having a physiologic pH of about 7.3.

In another exemplary embodiment, the reducing agent is at least one selected from reduced-glutathione and cysteinylglycine.

In another exemplary embodiment, the antioxidant is ascorbic acid.

In another exemplary embodiment, the powder formulation comprises the sugar, and wherein the sugar is selected from the group consisting of glucose, fructose, mannose and ribose.

In another exemplary embodiment, the sugar is D-glucose.

In another exemplary embodiment, the powder formulation comprises a nitric oxide substrate. The nitric oxide substrate can be L-arginine.

In another exemplary embodiment, the cytoprotectant formulation comprises reduced glutathione; L-ascorbic acid; D-glucose; a buffering agent; and the physiologically acceptable salts.

In another exemplary embodiment, the cytoprotectant formulation comprises reduced glutathione; L-ascorbic acid; D-glucose; L-arginine; a buffering agent; and the physiologically acceptable salts.

In another exemplary embodiment, the physiologically acceptable salts comprise: anhydrous calcium chloride; potassium phosphate monobasic; anhydrous magnesium sulfate; anhydrous magnesium chloride; anhydrous magnesium chloride; anhydrous sodium phosphate dibasic; anhydrous potassium chloride; and sodium bicarbonate.

In another exemplary embodiment, the powder formulation comprises: reduced glutathione, L-ascorbic acid, and sugar in amounts that produce a reconstituted formulation having a concentration of the sugar from about 5 mM to about 50 mM, a concentration of the L-glutathione from about 50 μM to about 3000 μM, and a concentration of the L-ascorbic acid from about 500 μM to about 4000 μM.

In another exemplary embodiment, the powder formulation comprises: reduced glutathione, L-ascorbic acid, the sugar and the L-arginine in amounts that produce a reconstituted formulation having a concentration of the L-arginine from about 250 μM to about 2000 μM, a concentration of the sugar from about 5 mM-50 mM, a concentration of the L-glutathione from about 50 μM to about 3000 μM, and a concentration of the L-ascorbic acid from about 500 μM to about 4000 μM.

In another exemplary embodiment, the powder formulation does not include sodium chloride.

Another exemplary embodiment of this invention is directed to a method for storing or transporting cells, tissues or organs, and biopsies derived from cells, tissues and organs, comprising: preparing a cytoprotectant formulation by mixing a first precursor solution comprising a balanced salt solution having a pH of from 7.6 to about 8.0 and a second precursor solution comprising water, D-glucose, glutathione, ascorbic acid, and optionally L-arginine, at a pH of about 3-5; extracting the cells, tissues or organs during a biopsy procedure; and storing or transporting the cells, tissues or organs in the cytoprotectant formulation.

In another exemplary embodiment, the sterile water medium is a water-for-injection medium.

In another exemplary embodiment, the saline medium is a 0.9% sodium chloride solution.

In another exemplary embodiment, the cells, tissues or organs and biopsies derived from cells, tissues and organs, are stored or transported at a temperature of at least 4° C.

In another exemplary embodiment, the tissues or organs are selected from the group consisting of fat or fat tissue grafts, saphenous veins, mammary tissue, internal thoracic/mammary arteries, epigastric arteries, gastroepiploic arteries, radial arteries, mammary tissues, heart, lungs, kidney, brain, muscle grafts, skin, intestine, bone, appendages, eyes, and portions of said tissues or organs.

In another exemplary embodiment, the cells can include stem cells, induced pluripotent cells, multipotent cells, differentiated cells, cell lines, primary cell cultures, and other types of cells can be used for research or therapeutic purposes. In some embodiments, the cells can be selected from the group consisting of cells obtained from a biopsy procedure, cell lines, primary cell cultures, and 3D cell cultures.

In another exemplary embodiment, the biopsy procedure is needle biopsy, aspiration biopsy, core biopsy, vacuum-assisted biopsy, excisional biopsy, incisional biopsy, shave biopsy, punch biopsy, endoscopic biopsy, laparoscopic biopsy, oral biopsy, cardiac biopsy, endometrial biopsy, endoscopic biopsy, lymph node biopsy, image-guided biopsy, surgical biopsy, or a combination thereof.

In another exemplary embodiment, the cells, tissues or organs, and biopsies derived from cells, tissues and organs, are under hypoxic or ischemic conditions.

It should be understood that the various individual aspects and features of the present invention described herein can be combined with any one or more individual aspect or feature, in any number, to form embodiments of the present invention that are specifically contemplated and encompassed by the present invention.

### DETAILED DESCRIPTION

Further aspects, features and advantages of this invention will become apparent from the detailed description which follows.

As used herein, the singular forms “a”, “an” and “the” are intended to include the plural forms as well, unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of an alloy or composite material, or other properties and characteristics, up to and including a variation of ±10%. All of the values characterized by the above-described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the end-points of the range. As an example, a variable which is described as having values between 0 and 10, can be 0, 4, 2-6, 2.75, 3.19-4.47, etc.

In the specification and claims, the singular forms include plural referents unless the context clearly dictates otherwise. As used herein, unless specifically indicated otherwise, the word “or” is used in the “inclusive” sense of “and/or” and not the “exclusive” sense of “either/or.”

Unless indicated otherwise, each of the individual features or embodiments of the present specification are combinable with any other individual feature or embodiment that are described herein, without limitation. Such combinations are specifically contemplated as being within the scope of the present invention, regardless of whether they are explicitly described as a combination herein.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described. For purposes of the present invention, the following terms are defined below.

As used herein, the term “patient” includes members of the animal kingdom including but not limited to human beings.

As used herein, “organ” includes, but is not limited to, the heart, veins, arteries, lungs, liver, pancreas and the kidneys. Portions of organs are also contemplated.

As used herein, “tissue” includes, but is not limited to mammalian tissue, including animal or human tissue, which can be connective, muscle, nervous, adipose, blood or epithelial tissues, and can include a single tissue or a collection of tissues that form a common function.

As used herein, “sterile water” includes, but is not limited to, (a) sterile water for injection, USP, (b) sterile distilled deionized water, and (c) sterile water for irrigation.

As used herein, “moderate hypothermia” is about 10° C. to about 21° C.

As used herein, an “antioxidant” is a substance that, when present in a mixture or structure containing an oxidizable substrate biological molecule, delays or prevents oxidation of the substrate biological molecule. For example, ascorbic acid is an antioxidant.

As used herein, a “balanced salt solution” is defined as an aqueous solution that is osmotically balanced to prevent acute cell or tissue damage.

As used herein, a “buffered salt solution” is defined as a balanced salt solution to which chemicals have been added to maintain a predetermined physiological pH range.

As used herein, a “cellular reducing agent” is defined as a substance that loses electrons easily thereby causing other substances to be reduced chemically.

As used herein, a “buffering agent” is a chemical compound or compounds (generally a weak acid or base or combination thereof) that maintains the pH of a solution in a desired range. Examples of physiologically tolerated buffers are, for example, acetate, bicarbonate, citrate, sodium phosphate, succinate, histidine, sulfate, nitrate, and pyruvate buffers, but are not limited thereto.

As used herein, a “pH adjusting agent” is chemical compound that can raise or lower pH when added to a solution. Preferred pH adjusting agents include HCl for lowering pH and NaHCO₃ for raising pH, but are not limited thereto.

As used herein, an “isotonic solution” refers to a solution that has the same salt concentration as cells and blood.

As used herein a “physiologic solution” is defined as an aqueous salt solution which is compatible with normal tissue, by virtue of being isotonic with normal interstitial fluids and having physiological pH.

As used herein, a “physiologically acceptable salt” refers to inorganic or organic salts, including, but not limited to, buffer salts, which are not deleterious to cell health or integrity.

As used herein, a “powder formulation” is defined as a dry, solid substance, composed of finely divided components (salts/organics) with or without excipients and intended for internal or external use. It is a solid substance in finely divided state typically obtained by crushing, grinding, milling and/or comminuting. In a preferred embodiment, the components of the powder formulation can be anhydrous.

As used herein, a “saline solution” is defined as an NaCl solution used in surgical and medical treatment processes.

As used herein, “sem” means standard error of the mean.

As described above, the present invention is directed to use of a cytoprotectant formulation that includes three primary components: glutathione, ascorbic acid and glucose, in combination with a balanced salt solution for the transport and/or storage of cells and tissues. In some embodiments, the methods provided include exposing the cells or tissues to a cytoprotectant formulation described herein that supports the viability of cells and tissues during transport and prior to processing. In some embodiments, the methods include exposing cells or tissues to a cytoprotectant formulation described herein to support the viability of cells and tissues harvested during biopsy procedures during transport and prior to use or testing and/or fixation of the harvested cells and tissues. The cytoprotectant formulation is a biocompatible solution.

The cytoprotectant formulation includes reduced glutathione at a concentration of about 50 μM to about 3000 μM, L-ascorbic acid at a concentration of about 500 μM to about 4000 μM, sugar at a concentration of about 5 mM to about 50 mM, and optionally, L-arginine at a concentration of about 250 μM to about 2000 μM. In the cytoprotectant formulation, the concentration of glutathione can be about 50 μM to about 2500 μM, about 60 μM to about 2000 μM, about 65 μM to about 1500 μM, about 70 μM to about 1000 μM; the concentration of L-ascorbic acid can be about 550 μM to about 3500 μM, about 600 μM to about 3000 μM, about 650 μM to about 2500 μM, about 700 μM tot about 2000 μM; the concentration of the sugar can be about 5.1 mM to about 45 mM, about 5.2 mM to about 40 mM, about 5.3 mM to about 35 mM, about 5.4 mM to about 30 mM, about 5.5 mM to about 25 mM, about 5 mM to about 20 mM, the concentration of L-arginine can be about 300 μM to about 1750 μM, about 350 μM to about 1500 μM, about 400 μM to about 1250 μMm, about 500 μM to about 1000 μM, and the like. The amount(s) of the various components are not limited hereto, and can include any values within any of the recited ranges and/or combinations thereof.

In the methods provided herein, the cytoprotectant formulation may be formulated as two solutions, Solution A and Solution B. The first solution, or Solution A, can include a balanced salt solution. The balanced salt solution is comprised of water and physiologically acceptable salts. A typical balanced salt solution can comprise water, calcium ions, chloride ions, potassium ions, phosphate ions, magnesium ions and sodium ions.

The balanced salt solution includes salts selected from among the following: calcium chloride, potassium chloride, potassium phosphate monobasic, magnesium chloride, magnesium sulfate, sodium chloride, sodium bicarbonate, sodium phosphate dibasic and combinations thereof. The salts can be of any hydration form including anhydrous. The balanced salt solution can be provided at a concentration that will result in an isotonic solution when the first and second solutions are mixed together. The components of Solution A are dissolved together in water and the pH of the resultant solution is adjusted to preferably about 7.4-8.0 by the addition of a base (Buffer), such as sodium bicarbonate. Hydrated and non-hydrated forms of any of the above components can be included in the balanced salt solution.

The second solution, Solution B, can include reduced glutathione, a reducing agent such as ascorbic acid; a sugar such as D-glucose, and optionally L-arginine, a buffering agent, and water which has been purged with an inert gas, such as argon, to remove substantially all dissolved oxygen (preferably to less than 0.1 ppm). The pH of the resultant Solution B is less than 7 and generally from 3 to 5. As an alternative, cysteinylglycine can be substituted for reduced glutathione or a mixture of cysteinylglycine and reduced glutathione can be present in Solution B. In a most preferred formulation, the pH of Solution A is 8.0 and the pH of Solution B is about 3.0. Importantly, when solution A is mixed with Solution B, it must yield a solution having a physiological pH; pH 7.3+/−0.4.

More specifically, Solution B is a solution of organic components in a separate container from Solution A and comprises L-glutathione, L-ascorbic acid, D-glucose, optionally L-arginine and water-for-injection at a pH of 3.0-5.0. Other sugars that can be used in place of glucose are any sugar but preferably any monosaccharide including but not limited to fructose, mannose and ribose. When Solutions A and B are mixed at the point of use, the pH of the mixed solution is 7.3±0.4. The pH of the Solutions A and B can be adjusted using many known pH adjusting agents. Preferred pH adjusting agents are 4N HCl and 84% NaHCO₃. The pH of Solution A can be about 7.5 to about 8.0and the pH of Solution B can be about 4.0, and more preferably the pH of Solution A is about 7.5 to about 7.8and the pH of Solution B is 3.0.

Certain pH values for Solution A and Solution B are described herein, but the pH values of these two solutions are not limited thereto. The pH values of Solution A and/or Solution B are not limited so long as the cytoprotectant formulation obtained by mixing Solution A and Solution B has a physiological pH 7.3±0.4.

The salts in the solution are intended for buffering (maintaining pH) and to maintain isotonicity, ionic balance and biocompatibility with respect to cells, and tissues, such as cells and tissues harvested during biopsy procedures during transport and prior to processing of the harvested cells and tissues. The organic components are intended to maintain additional buffering capability, osmolality and to provide a non-oxidizing environment (and prevent oxidation to) to cells, and tissues. The organic components: L-glutathione, L-ascorbic acid, and D-glucose, and optionally L-arginine, are included for their roles in preserving and maintaining the extracellular environment of vascular conduits, cells, and tissues.

L-glutathione and L-ascorbic acid are antioxidants that prevent oxidative damage to cells by reacting with and thereby minimizing free radicals. The functions of these antioxidants are: 1) to stabilize other components of the solution by preventing oxidation, thereby improving the stability and shelf life of product; and 2) to prevent oxidative damage to cell membranes and extracellular matrix structures. The sugar is intended to provide an energy source for the cells, tissue or organ, and biopsies derived from cells, tissues and organs, under ischemic and hypoxic conditions. Under such ischemic and/or hypoxic conditions, the cytoprotectant formulation is biocompatible and reduces oxidative damage and oxidative stress that occurs during hypoxia/ischemia, and also supports anerobic metabolism during periods of ischemia and/or hypoxia.

The first or second formulations (Solutions A or B) may optionally include an anticoagulant in an amount sufficient to help prevent clotting of blood within the vasculature of a tissue or organ if required for specific tissue/cell storage. Exemplary anticoagulants include heparin and hirudin, but other anticoagulants such as aspirin may be used. An exemplary embodiment includes heparin in concentration ranges from about 50 units/mL to about 250 units/mL. Heparin can also be added separately after Solutions A and B have been combined and prior to use.

The preferred volumetric ratio of Solution A to Solution B can be about 19:1. For example in one embodiment, 950 ml of Solution A is mixed with 50 ml of Solution B to result in the final cytoprotectant formulation. In another embodiment, 19 ml of Solution A is mixed with 1 ml of Solution B to result in the final cytoprotectant formulation.

A second alternative cytoprotectant formulation includes a Solution A, which includes a sugar such as glucose, mannose, fructose or the like, in combination with a balanced salt solution at a pH of 7.4 to 8 and a second Solution B, which comprises reduced glutathione, ascorbic acid, optionally L-arginine, a buffering agent in water at a pH below 7, generally 5, 4 or 3, which may be stored in an oxygen-free environment.

Generally, neither Solution A or B in either embodiment will include other organic components other than those specifically listed, as these would be unnecessary and increase production costs. Additionally, cysteinylglycine can be substituted for reduced glutathione or a mixture of cysteinylglycine and reduced glutathione can be included in these solutions.

The two solutions that are mixed to form the cytoprotectant formulation may be packaged separately or in a divided container, such as described in U.S. Pat. No. 5,257,985, the contents of which are incorporated as if fully set forth herein. Further details of Solutions A and B are described in U.S. Pat. Nos. 7,981,596 and 11,291,201, the contents of each of which are incorporated as if fully set forth herein. The volume of Solutions A and B and/or the volume of any packaging comprising either Solution A or Solution B is not limited, and the volumes thereof can be adjusted to yield a post-mixing cytoprotectant formulation having a volume including, but not limited to about 1 ml, about 5 ml, about 10 ml, about 15, about 20 ml, about 25 ml, about 50 ml, about 100 ml, about 250 ml, and the like.

The cytoprotectant formulation can also be prepared by reconstituting a powder formulation including glutathione; a reducing agent such as ascorbic acid; a sugar such as D-Glucose; (optionally a nitric oxide substrate such as L-arginine); a buffering agent, and physiologically acceptable salts. Cysteinylglycine can be substituted for reduced glutathione or a mixture of cysteinylglycine and reduced glutathione can be present in the powder formulation. Any suitable sugar can be used in place of glucose, but preferably any monosaccharide including but not limited to fructose, mannose and ribose can be used. The powder formulation can include a reduced glutathione, a reducing agent, a buffering agent, and physiologically acceptable salts, and/or the powder formulation can exclude one or more of the sugar and/or arginine.

Optionally, the powder formulation does not include sodium chloride (NaCl) prior to reconstitution. The powder formulation can be reconstituted in water or, if the powder formulation does not contain NaCl, the powder formulation can be reconstituted in normal saline. Optionally, one or more of the components of the powder formulation may be provided as a liquid formulation that is added at the time of reconstitution of the powder formulation to yield the cytoprotectant formulation. For example, calcium chloride can be added as a separate liquid component that is added during reconstitution of the powder formulation. The volume of the reconstituted powder formulation and/or the volume of any packaging comprising the reconstituted powder formulation is not limited, and the amount of powder formulation provided in a vessel, such as a vial, can be adjusted to yield a reconstituted cytoprotectant formulation having a volume including, but not limited to about 1 ml, about 5 ml, about 10 ml, about 15, about 20 ml, about 25 ml, about 50 ml, about 100 ml, about 250 ml, and the like.

Further details of powder formulations are described in U.S. Provisional Application No. 63/331,777, the contents of which are incorporated as if fully set forth herein.

Also provided are methods for storing or transporting cells, tissues, or organs, and biopsies derived from cells, tissues and organs. Conventional ischemic (away from the body and blood supply) storage can adversely affect cells, such as inducing cellular ionic imbalances, ischemia injury, hypoxic stress, disruptions in membrane potential, generation of metabolic stress lesions and generation of reactive oxygen species that can damage cells. The cytoprotectant formulations provided herein minimize, alleviate, or prevent one or more, or all of these, negative impacts on the cells. The methods provided herein include combining the cells, organs, or tissue with a cytoprotectant formulation provided herein, and storing the combination at a temperature in a range of about 1° C. to about 40° C. The storage temperature can be lower than a temperature used for culturing cells, or the normal body temperature of a mammalian subject, while maintaining viability of the cells.

The methods provided herein can be used for the storage and transport of any cell type. The cells can be eukaryotic or prokaryotic. The cells can be animal cells, insect cells, bacterial cells, plant cells, or yeast cells. The animal cells can be human cells. The cells can be undifferentiated cells, precursor cells, or combinations thereof. The cells can be cancer cells, cardiac tissue cells, connective tissue cells, dendritic cells, endothelial cells, epithelial cells, fibroblasts, genetically modified cells, hematopoietic cells, immune system cells, keratinocytes, mesenchymal cells, muscle cells, multipotent cells, neuronal cells, omnipotent cells, pluripotent cells, precursor cells, progenitor cells, smooth muscle cells, stem cells, stromal cells, or tumor cells. The cells can be used in research, diagnostic, or therapeutical applications.

The methods described herein can also be used for storage and transport of any tissues, including portions thereof, including but not limited to tissues or portions thereof harvested during biopsy procedures. The biopsy procedures can include, but are not limited to, needle biopsy, aspiration biopsy, core biopsy, vacuum-assisted biopsy, excisional biopsy, incisional biopsy, shave biopsy, punch biopsy, endoscopic biopsy, laparoscopic biopsy, oral biopsy, cardiac biopsy, endometrial biopsy, endoscopic biopsy, lymph node biopsy, image-guided biopsy, surgical biopsy, and the like. The biopsy procedures can be related to testing for abnormalities in a cell or tissue sample. Biopsies are used for diagnosing cancerous and non-cancerous conditions, and can be performed on bone, brain, breast, colon, kidney, liver, lung, lymph node, prostate, skin, or other tissues. Biopsies can be useful for diagnosing and treating many conditions, including but not limited to cancer, leukemia, anemia, infection, lymphoma, inflammatory disorders, immune disorders, and the like.

### EXPERIMENTAL EXAMPLE 1—CYTOTOXICITY STUDIES

The biocompatibility of a cytoprotectant formulation was studied by performing cytotoxicity studies using an in an accepted standardized (ISO 10993) in vitro mammalian cell culture test, comparing the cytoprotectant formulation described herein to normal saline. Single strength Minimum Essential Medium supplemented with 5% fetal bovine serum, 2% antibiotics and 1% L-glutamine (1× MEM) was also used as a control and a rescue medium. Subconfluent cultures of L-929 mouse fibroblasts cells were incubated in the cytoprotectant formulation, saline solution, or 1× MEM for treatment times of 30 minutes, 60 minutes, 5 hours, and 24 hours. At the end of each treatment time, the cells were evaluated for cell lysis microscopically, rinsed, and then cultured in 1× MEM for an additional 24 hours. Following this 24 hour culture period, the cells were evaluated a second time for cell lysis microscopically. All experiments were conducted following Good Laboratory Procedures.

Mammalian cell culture monolayer consisting of L-929 mouse fibroblast cells (ECACC Catalog No. 85103115 or equivalent source) were propagated and maintained in flasks containing 1× MEM at 37° C. with 5% carbon dioxide (CO₂). For this study, 10 cm² wells were seeded, labeled with passage number and date, and incubated at 37° C. in 5% CO₂ to obtain subconfluent monolayers of cells prior to use. Aseptic procedures were used in the handling of the cell cultures following approved NAMSA (North American Science Associates, LLC) Standard Operating Procedures.

A cytoprotectant formulation as described herein was prepared. Solution A and Solution B, which were stored under refrigeration conditions, were equilibrated to ambient temperature for at least 1 hour before proceeding with the test.

The cytoprotectant formulation was prepared under aseptic conditions within 1 hour before treating the cell monolayers. 250 mL of Solution A was added to a sterile container and a 12.5 mL aliquot of Solution B was slowly added to Solution A with gentle mixing under aseptic conditions. The container containing the resulting cytoprotectant formulation was sealed to prevent contamination.

The cytoprotectant formulation is not limited to the liquid version prepared by mixing Solution A and Solution B, as described herein. A powder formulation as described herein also can be used after being reconstituted at point of use.

A 0.9% saline solution (normal saline), stored at ambient conditions and prepared under aseptic conditions, was also evaluated.

Thirty-six (36) cell culture wells were selected which contained a subconfluent cell monolayer. The growth medium in the cultures was removed and all wells were briefly washed with approximately 2 mL of their respective treatment formulation—the cytoprotectant formulation (12 wells), saline (12 wells) and 1× MEM control (12 wells). The cytoprotectant formulation, saline and 1× MEM control were removed from the respective wells and replaced with 2 mL of the prepared cytoprotectant formulation (12 wells), saline control (12 wells), and 1× MEM (12 wells), respectively.

The wells were incubated at 37° C. and 5% CO₂, for four different time periods. Three wells each were treated with the cytoprotectant formulation, saline, or 1× MEM after 30±3 minutes, 60±3 minutes, 5 hours±6 minutes and 24 hours±30 minutes and the cell lysis thereof evaluated, respectively, for a corresponding t=0 hour reading. Following the first evaluation at t=0 hour, the cytoprotectant formulation, saline, or 1× MEM was replaced with 2 mL of 1× MEM (rescue period). The nine cultures were then incubated at 37° C. in 5% CO₂ for 24±2 hours, and then again evaluated for percent lysis. The cultures were examined microscopically (100×) to evaluate cellular characteristics and percent lysis. The color of the test medium was observed following the last evaluation. Each culture well was evaluated for percent lysis and cellular characteristics using the grading set forth in TABLE 1:

| Grade | Reactivity | Conditions of all Cultures |
|---|---|---|
| 0 | None | Discrete intracytoplasmic granules, no cell lysis, no reduction of cell |
| | | growth. |
| 1 | Slight | Not more than 20% of the cells are round, loosely attached and without |
| | | intracytoplasmic granules, or show changes in morphology; occasional |
| | | lysed cells are present; only slight growth inhibition observable. |
| 2 | Mild | Not more than 50% of the cells are round, devoid of intracytoplasmic |
| | | granules; no extensive cell lysis; not more than 50% growth inhibition |
| | | observable |
| 3 | Moderate | Not more than 70% of the cell layers contain rounded cells or are lysed; |
| | | cell layers not completely destroyed, but more than 50% growth |
| | | inhibition observable. |
| 4 | Severe | Nearly complete or complete destruction of the cell layers. |

The results of the above-described tests are shown in TABLES 2-4. As shown by these results, the 1× MEM control displayed no reactivity (Grade 0) for all time points and observations. Compared to the saline control, the cytoprotectant formulation had equivalent reactivity (none; Grade 0) after the initial 30 minute incubation and at the observation of the 30-minute treated sample after 24 hours in 1× MEM. For the 60 minute, 5 hour, and 24 hour exposure time points, the cytoprotectant formulation had substantially lower reactivity compared to the saline control following both the initial observation and the observation 24 hours post-treatment. For instance, in the 5-hour treatment samples, the cytoprotectant formulation had no reactivity or slight reactivity (Grade 0 or 1) after the initial observation and the observation after 24 hours in 1× MEM, respectively, while the sample exposed to saline for 5 hours exhibited severe reactivity (Grade 4) after both observations.

No pH shift was observed following the second observation for reactivity in any cell culture well.

TABLE 2
30 Minute Measurement

| | | | | | |
|---|---|---|---|---|---|
| | | Percent Cells | | | |
| | | Without | | | |
| | | Intra- | | | |
| | Percent | cytoplasmic | Percent | | |
| Well | Rounding | Granules | Lysis | Grade | Reactivity |

First Observation at t = 0

| | | | | | |
|---|---|---|---|---|---|
| Cytoprotectant | 0 | 0 | 0 | 0 | None |
| Formulation | | | | | |
| Saline Control | 0 | 0 | 0 | 0 | None |
| 1× MEM | 0 | 0 | 0 | 0 | Nonc |
| Control | | | | | |

Second Observation at t = 24 hours in 1× MEM

| | | | | | |
|---|---|---|---|---|---|
| Cytoprotectant | 0 | 0 | 0 | 0 | None |
| Formulation | | | | | |
| Saline Control | 0 | 0 | 0 | 0 | None |
| 1× MEM | 0 | 0 | 0 | 0 | None |
| Control | | | | | |

TABLE 3
60 Minute Measurement

| | | | | | |
|---|---|---|---|---|---|
| | | Percent Cells | | | |
| | | Without | | | |
| | | Intra- | | | |
| | Percent | cytoplasmic | Percent | | |
| Well | Rounding | Granules | Lysis | Grade | Reactivity |

First Observation at t = 0

| | | | | | |
|---|---|---|---|---|---|
| Cytoprotectant | 0 | 0 | 0 | 0 | None |
| Formulation | | | | | |
| Saline Control | 30 | 30 | 30 | 2 | Mild |
| 1x MEM | 0 | 0 | 0 | 0 | None |
| Control | | | | | |

Second Observation at t = 24 hours in 1× MEM

| | | | | | |
|---|---|---|---|---|---|
| Cytoprotectant | 0 | 0 | 0 | 0 | None |
| Formulation | | | | | |
| Saline Control | 30 | 30 | 30 | 2 | Mild |
| 1× MEM | 0 | 0 | 0 | 0 | None |
| Control | | | | | |

TABLE 4
5 Hour Measurement

| | | | | | |
|---|---|---|---|---|---|
| | | Percent Cells | | | |
| | | Without | | | |
| | | Intra- | | | |
| | Percent | cytoplasmic | Percent | | |
| Well | Rounding | Granules | Lysis | Grade | Reactivity |

First Observation at t = 0

| | | | | | |
|---|---|---|---|---|---|
| Cytoprotectant | 0 | 0 | 0 | 0 | None |
| Formulation | | | | | |
| Saline Control | 90 | 90 | 90 | 90 | Severe |
| 1× MEM | 0 | 0 | 0 | 0 | None |
| Control | | | | | |

Second Observation at t = 24 in 1× MEM

| | | | | | |
|---|---|---|---|---|---|
| Cytoprotectant | 10 | 10 | 10 | 1 | Slight |
| Formulation | | | | | |
| Saline Control | 90 | 90 | 90 | 4 | Severe |
| 1× MEM | 0 | 0 | 0 | 0 | None |
| Control | | | | | |

TABLE 5
24 Hour Measurement

| | | | | | |
|---|---|---|---|---|---|
| | | Percent Cells | | | |
| | | Without | | | |
| | | Intra- | | | |
| | Percent | cytoplasmic | Percent | | |
| Well | Rounding | Granules | Lysis | Grade | Reactivity |

First Observation at t = 0

| | | | | | |
|---|---|---|---|---|---|
| Cytoprotectant | 10 | 10 | 10 | 1 | Slight |
| Formulation | | | | | |
| Saline Control | Not | Not | 100 | 4 | Severe |
| | applicable | applicable | | | |
| 1× MEM | 0 | 0 | 0 | 0 | None |
| Control | | | | | |

Second Observation at t = 24 in 1× MEM

| | | | | | |
|---|---|---|---|---|---|
| Cytoprotectant | 10 | 10 | 10 | 1 | Mild |
| Formulation | | | | | |
| Salinc Control | 90 | 90 | 90 | 4 | Severe |
| 1× MEM | 0 | 0 | 0 | 0 | None |
| Control | | | | | |

These results demonstrate that the cytoprotectant formulation successfully can be used as a medium for the transport or storage of cells and tissues, as the cytoprotectant formulation supports the viability of cells, unlike saline, which proved to be cytotoxic after as little as 5 hours.

Based on the results of Experimental Example 1, the inventors of this application contemplated the use of the cytoprotectant formulation for storage and transport of cells, tissues and organs harvested during biopsy procedures, or for the storage and transport of cells, tissues and organs used for research. Cells, tissues and organs harvested during biopsy procedures and/or those used in research are generally stored and transported under hypoxic conditions, and cell and tissue culture media do not support anaerobic metabolism. Under such conditions, the cytoprotectant formulation reduces oxidative damage and oxidative stress, which can maintain viability of the cells, tissues and organs during storage and transport. The following prophetic examples are intended to demonstrate the suitability of the cytoprotectant formulation for storage and transport of cells, tissues and organs, including but not limited to biopsies derived from cells, tissues and organs and cells, tissues and organs used in research.

### PROPHETIC EXAMPLE 1

In a contemplated long-term study, thirty-six (36) additional subconfluent cell monolayer-containing cell culture wells are selected, and processed as described in Experimental Example 1. The wells are then incubated at 37° C. and 5% CO₂, for 36 hours±30 minutes, 48 hours±30 minutes and 72 hours±30 minutes and the cell lysis evaluated, respectively, for a corresponding t=0 hour reading. Following the first evaluation at t=0 hour, the cytoprotectant formulation, saline, or 1× MEM are replaced with 2 mL of 1× MEM, and the cultures are further incubated at 37° C. in 5% CO₂ for 24±2 hours, and again evaluated for percent lysis. The cultures would be examined as described above.

It is expected that the cytoprotectant formulation would continue to have lower reactivity compared to the saline control following both the initial observation and observations 36 hours, 48 hours and 72 hours post-treatment, in light of the complete cell lysis observed after 24 hours of treatment with saline.

### PROPHETIC EXAMPLE 2

In a contemplated long-term study, additional subconfluent cell monolayer-containing cell culture wells are selected, and processed as described in Experimental Example 1, with the exception that no MEM control is included in this study. The wells are then incubated under ambient conditions at room temperature for 36 hours±30 minutes, 48 hours±30 minutes, 72 hours±30 minutes and 168 hours±12 hours and the cell lysis evaluated and the cultures examined as described above after each time period. It is expected that the incubated cells will show no reactivity or minimal reactivity for the cytoprotectant formulation for all the studied time periods and will show reactivity for saline in as little as 1 hour of exposure, thereby demonstrating the unexpectedly superior viability of cells stored in the cytoprotectant formulation even after prolonged exposure to the cytoprotectant formulation.

The storage and/or transport times of cells and tissues in the cytoprotectant formulation is not limited to the times studies in these examples, and can include any reasonable time, such as a period of hypoxic and ischemic conditions, including but not limited to about 30 seconds, about 1 minute, about 5 minutes, about 10 minutes, about 30 minutes, about 1 hour, about 5 hours, about 10 hours, about 24 hours, about 48 hours, about 72 hours, about 168 hours, and the like, including any intervening time.

The storage and/or transport temperatures of cells and tissues in the cytoprotectant formulation is not limited to the temperature studies in these examples, and can include any reasonable time, including but not limited to about 1° C. to about 40° C., about 2° C. to about 35° C., about 4° C. to about 30° C., about 8° C. to about 35° C., about 12° C. to about 30° C., and the like, including any intervening temperature in these ranges.

### PROPHETIC EXAMPLE 3

In a contemplated example, pig mammary vein (PMV) samples are collected and immediately flushed and submerged in normal saline (0.9% sodium chloride) or cytoprotectant formulation for various amounts of time ranging from 45 minutes to 24 hours. The PMV samples are then fixed in neutral buffered formalin, rinsed in phosphate buffered saline and placed in 70% ethanol. Vein harvesting through tissue fixation is performed, and then processed, embedded in paraffin, sectioned and stained with hematoxylin and eosin (H&E) or processed for immunohistochemistry evaluation using endothelial cell surface markers such as CD31, von Willebrand Factor (vWF) and caspase-3. In the contemplated example, a total of four cross-sections from each vein sample are evaluated for H&E staining and for each individual immunostaining: CD31, Von Willebrand factor (vWF) and caspase-3. For each stained section, approximately 15-28 high-powered fields are evaluated, with the exact number of fields evaluated depended upon the circumference of the cross-section stained, which can range from 6.3 mm for a cross-section with a 2 mm diameter to 12.6 mm for a section that represents a vein with a diameter approaching 4 mm: a total range of between 60 and 112 fields are evaluated over four different cross-sections of each vein segment for each analysis. All histological staining and pathology evaluations are performed according to Good Laboratory Practice.

Staining is subsequently performed using sections of PMV samples. Three sets of slides are deparaffinized with xylene and rehydrated with a series of alcohol baths. The slides are rinsed in distilled water and submerged in rodent decloaking solution (Biocare, RD913). Heat-induced antigen retrieval is performed using a Biocare Decloaking Chamber. After cooling to room temperature, IP FLX Peroxidase (Biocare, IPB5000) and Background Punisher (Biocare, BP974M) is used to block the tissues. Anti-CD31 (Abcam, ab28364), at a ratio of 1:50, is placed on one set of slides for 1 hour at room temperature. The second set of slides is incubated in anti-vWF (Dako, A0082) at a ratio of 1:300, for 1 hour at room temperature. The third set of slides is incubated in anti-caspase 3 (Abcam, ab13847) at 1:500, for 2 hours at room temperature. Additional slides are prepared and incubated in each of the above reagents for extended time periods, including 24 hours, 36 hours, 48 hours and 72 hours.

The results would be expected to show that the cytoprotectant formulation maintains the viability of the cells, tissues and organs, and biopsies derived from cells, tissues and organs, stored in this medium over extended time periods ranging from 24 hours to 72 hours.

In addition to ischemic injury that occurs during transport and ischemic storage, exposing a tissuc or organ to a solution with low biocompatibility can also result in direct injury to tissue. Biocompatibility of a solution can be impacted through chemical characteristics including pH, tonicity and/or ionic balance, or through cytotoxicity mediated by one or more of the solution components. Low biocompatibility coupled with an inability to protect against oxidative damage run counter to the qualities identified for a storage and transport solution. As demonstrated by the results in this application, the methods provided herein utilize a cytoprotectant formulation that is biocompatible with test cells even after 24 hours of exposure, whereas normal saline is cytotoxic. Saline-treated cells exhibited severe reactivity when exposed to saline for as little as 5 hours. Further, the results of the prophetic examples are expected to show the superior storage and transport properties of the cytoprotectant formulation for cells, tissues and organs, including biopsied cells, tissues and organs, because the cytoprotectant formulation maintains the viability of the cells, tissues and organs stored in this medium over extended time periods ranging from 24 hours to 168 hours under various conditions.

1. A method for storing or transporting cells, tissues or organs, comprising:
reconstituting a powder formulation in a saline or sterile water media to form a cytoprotectant formulation;
extracting the cells, tissues or organs during a biopsy procedure; and
bringing the cells, tissues or organs into contact with the cytoprotectant formulation, and
storing the cells, tissues or organs in the cytoprotectant formulation,
wherein the powder formulation comprises a reducing agent; an antioxidant; a sugar;
optionally a nitric oxide substrate; a buffering agent; and a physiologically acceptable salt, and
wherein the powder formulation when reconstituted at a point of use in a saline or sterile water media forms a reconstituted formulation having a pH of about 7.

2-23. (canceled)
